(19) United States
(12) Patent Application Publication
(10) Pub. No.: US 2026/0338594 A1
(43) Pub. Date: Oct. 29, 2026

(54) Multi-Mode Scale

(71) Applicant: The A.H. Emery Co., Seymour, CT (US)

(72) Inventors: Peter Siegrist, Seymour, CT (US); Jeffrey Vasisko, Seymour, CT (US)

(21) Appl. No.: 19/640,565

(22) Filed: Apr. 7, 2026

Related U.S. Application Data
(60) Provisional application No. 63/790,277, filed on Apr. 17, 2025.

(51) Int. Cl. G01G 23/18; G01G 3/13; G01G 3/14; G01G 21/22; G01G 21/28; G06F 3/04886

(52) U.S. Cl. CPC G01G 23/18; G01G 3/13; G01G 3/14; G01G 21/22; G01G 21/28; G06F 3/04886

(57) ABSTRACT

A digital scale may include a platform; an electrical sensor connected to the platform; a processor connected to the electrical sensor; and a touchscreen interface connected to the processor. The processor is configured to implement a first mode of the touchscreen interface displaying at least a first value measured by the electrical sensor, and a first control button, and the processor is configured to implement a second mode of the touchscreen interface displaying at least a second control button that is different from the first control button. The touchscreen may be integrated into a housing that supports the platform and contains the electrical sensor.

### TECHNICAL FIELD

The present disclosure relates to equipment for weighing objects.

### BACKGROUND

Scales have been known since antiquity for the purpose of measuring weight. Different types of scales include the merchant's balance, the postage meter scale, and the truck scale. Scales have various means for displaying the measured weight of an object or objects. The merchant's scale has a stack of true weights that can be counted to estimate the measured weight. The postage meter scale may have an analog dial or an LCD readout. The truck scale may have an LCD readout, an analog dial, or an integrated laptop.

### SUMMARY

According to embodiments of the disclosure, a digital scale may include a platform; an electrical sensor connected to the platform; a processor connected to the electrical sensor; and a touchscreen interface connected to the processor. The processor is configured to implement a first mode of the touchscreen interface displaying at least a first value measured by the electrical sensor, and a first control button, and the processor is configured to implement a second mode of the touchscreen interface displaying at least a second control button that is different from the first control button. The touchscreen may be integrated into a housing that supports the platform and contains the electrical sensor.

According to embodiments of the disclosure, a multimode scale may include a housing; a load cell in the housing; a platform mounted to the housing and movably connected with the load cell; a processor in the housing and connected in communication with the load cell; a memory for storing data measured by the load cell as a function of time; a touchscreen in the housing and connected in communication with the processor; and at least first and second interfaces stored in the memory for display on the touchscreen, wherein the first interface is configured to implement a first mode of the scale to display a first value measured by the load cell and a first control button on the touchscreen, and wherein the second interface is configured to implement a second mode of the scale to display a second value measured by the load cell and a second control button on the touchscreen.

Other features and aspects of the present teachings will become apparent from the following detailed description, taken in conjunction with the accompanying drawings, which illustrate by way of example the features in accordance with embodiments of the present teachings. The summary is not intended to limit the scope of the present teachings.

### BRIEF DESCRIPTION OF DRAWINGS

The present teachings are described more fully hereafter with reference to the accompanying drawings, which depict example embodiments. The following description illustrates the present teachings by way of example, not by way of limitation of the principles of the present teachings.

FIGS. 1–3 are schematic depictions of a multimode digital scale 100 with various interfaces 114, 116, 128 displayed at its touchscreen 112.

FIG. 4 depicts a plurality of different interfaces that may be displayed at the touchscreen 112.

It should be understood that throughout the drawings, corresponding reference numerals indicate like or corresponding parts and features.

### DETAILED DESCRIPTION

For purposes of explanation and not limitation, specific details are set forth such as particular structures, architectures, interfaces, techniques, etc., in order to provide a thorough understanding. In other instances, detailed descriptions of well-known devices and/or methods are omitted so as not to obscure the description with unnecessary detail.

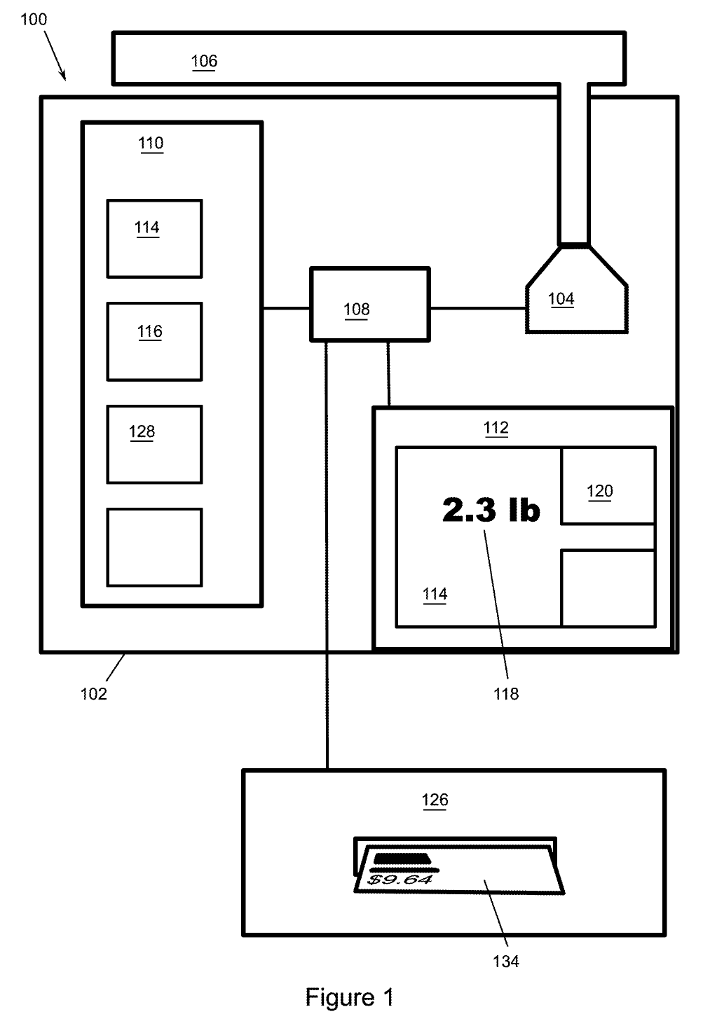

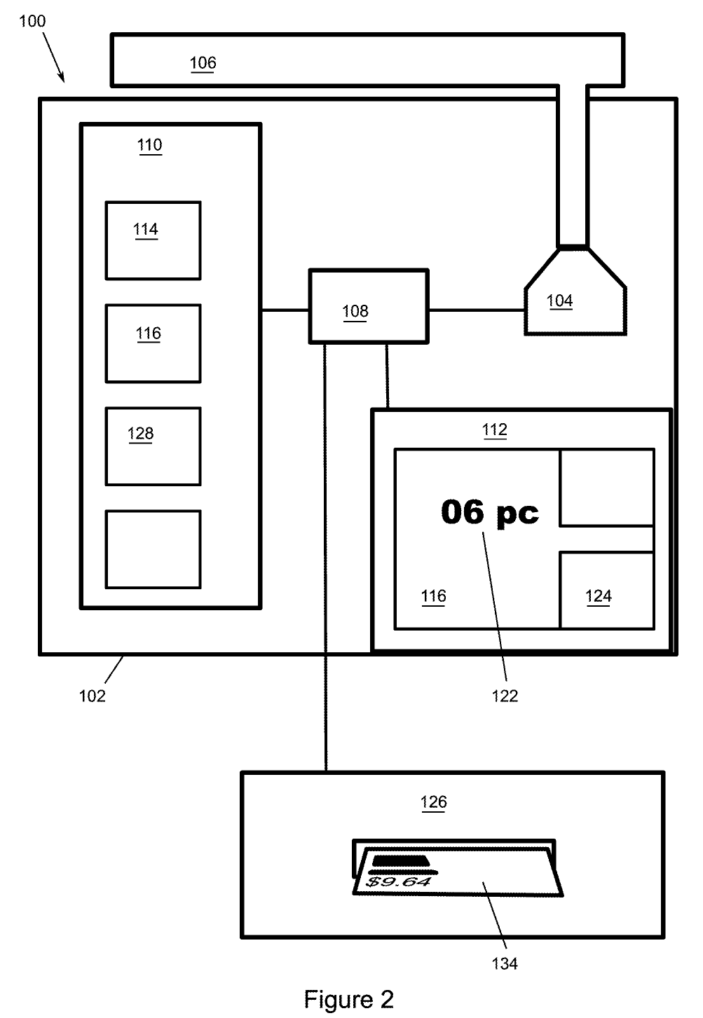

Drawing FIGS. 1 and 2 show a multimode digital scale 100, which includes a housing 102; an electrical sensor (e.g., a load cell, which may incorporate for example, a piezoelectric crystal or a resistive strain gage) 104 in the housing; a platform 106 mounted to the housing and movably connected with the load cell; a processor 108 in the housing and connected in communication with the load cell; a memory 110 connected in communication with the processor for storing data measured by the load cell as a function of time; a touchscreen 112 in the housing and connected in communication with the processor; and at least first and second interfaces 114, 116 that are stored in the memory, wherein the processor is configured to retrieve the interfaces from the memory and implement the interfaces for display on the touchscreen according to actuations of control buttons in the various interfaces. The first interface 114 (as shown in FIG. 1) may be configured to implement a first mode of the scale to display a first value 118 (e.g., a total weight on the platform in pounds or “lb” as measured by the load cell) and a first control button 120 on the touchscreen. The second interface 116 (as shown in FIG. 2) may be configured to implement a second mode of the scale to display a second value 122 (e.g., a count of items or “pc,” possibly along with an average weight of each unit or item placed on the platform, as measured by the load cell and the processor) and a second control button 124 on the touchscreen. Each interface may include one or more control buttons that can be actuated to cause display of other respective interfaces.

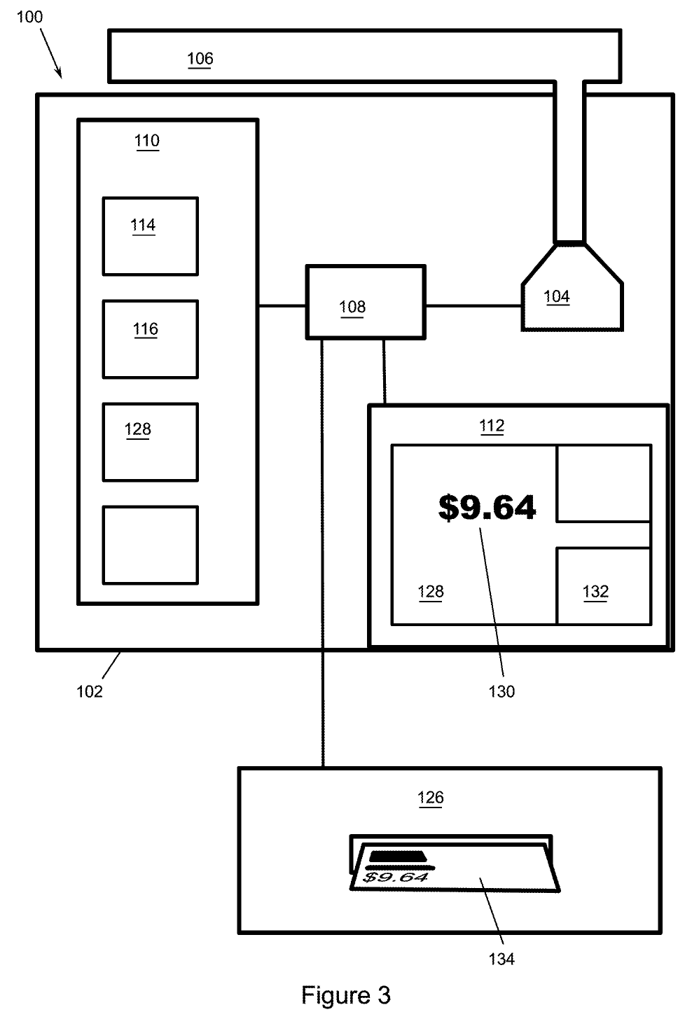

The scale 100 may include a label printer 126. The processor may be configured to display at the touchscreen, in response to actuation of a control button in one or more of the interfaces, a third interface 128 (as shown in FIG. 3) with a third value 130 (i.e., postage calculated by the processor) and a third control button 132 for causing the processor to print postage 134 using the label printer. The printed postage may correspond to a total weight on the platform when the postage is printed, based on a lookup table or formula calculated by the processor.

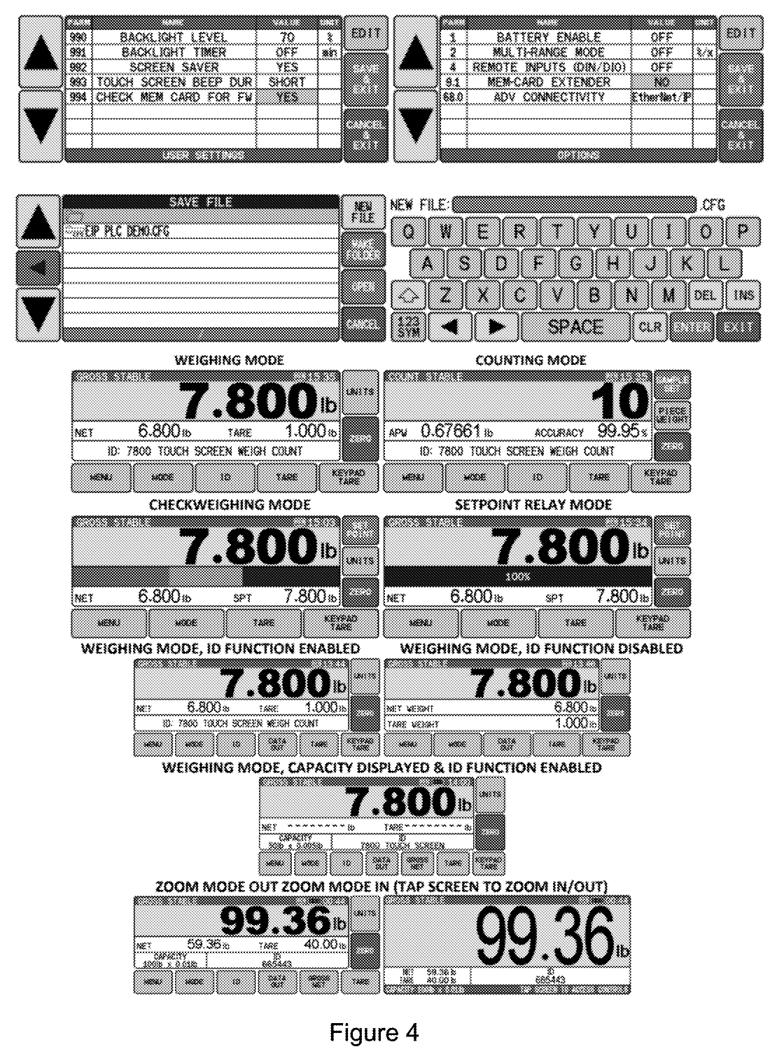

There may be two, three, four, or even more interfaces available for display at the touchscreen, as shown in FIG. 4 (color drawing). Each interface may have one or more different colors than another interface. The different interfaces may have differing numbers and arrangements of control features such as "buttons" that can be actuated via the touchscreen. Each interface may display one or more values measured by the electrical sensor and the processor, e.g., one interface may display a total weight measured by the electrical sensor while another interface may display an item count and an average item weight measured by the electrical sensor and the processor. Each interface may include at least one control button to cause display of a different interface.

The present teachings have been described in language more or less specific as to structural, mechanical, and functional features. It is to be understood, however, that the present teachings are not limited to the specific features shown and described, since the apparatus, system, and/or method herein disclosed comprises preferred forms of putting the present teachings into effect.

Generally, all terms used in the claims are to be interpreted according to their ordinary meaning in the technical field, unless explicitly defined otherwise herein. All references to a/an/the element, apparatus, component, means, step, etc., are to be interpreted openly as referring to at least one instance of the element, apparatus, component, means, step, etc., unless explicitly stated otherwise. The use of “first,” “second,” etc., for different features/components of the present disclosure are only intended to distinguish the features/components from other similar features/components and not to impart any order or hierarchy to the features/components, unless explicitly stated otherwise. The phrase “at least one of,” when used with a list of items, means that different combinations of one or more of the listed items may be used, and only one item in the list may be needed. For example, “at least one of: A, B, and C” includes any of the following combinations: A; B; C; A and B; A and C; B and C; and A and B and C.

Other than in the operating examples, or where otherwise indicated, all numbers expressing quantities of ingredients or reaction conditions used herein are to be understood as modified in all instances by the term “about.”

While the present teachings have been described above in terms of specific embodiments, it is to be understood that they are not limited to those disclosed embodiments. Many modifications and other embodiments will come to mind to those skilled in the art to which this pertains, and which are intended to be and are covered by both this disclosure and the appended claims. For example, in some instances, one or more features disclosed in connection with one embodiment can be used alone or in combination with one or more features of one or more other embodiments. It is intended that the scope of the present teachings should be determined by proper interpretation and construction of any claims and their legal equivalents, as understood by those of skill in the art relying upon the disclosure in this specification and the attached drawings.

1. A multimode scale comprising:
a housing;
a load cell in the housing;
a platform mounted to the housing and movably connected with the load cell;
a processor in the housing and connected in communication with the load cell;
a memory for storing data measured by the load cell as a function of time;
a touchscreen in the housing and connected in communication with the processor; and
at least first and second interfaces stored in the memory for display on the touchscreen, wherein the first interface is configured to implement a first mode of the scale to display a first value measured by the load cell and a first control button on the touchscreen, and wherein the second interface is configured to implement a second mode of the scale to display a second value measured by the load cell and a second control button on the touchscreen.

2. The scale of claim 1 wherein the first and second buttons relate to the first and second values.

3. The scale of claim 1 wherein the first and second interfaces both include a mode button for changing the interface displayed on the touch screen.

4. The digital scale of claim 1, wherein the second control button is in a different part of the touchscreen interface from the first control button.

5. The digital scale of claim 1, wherein the second mode of the touchscreen interface displays a second value that is a different type of value than the first value.

6. The digital scale of claim 1, wherein the processor is configured to count increments of weight sensed by the load cell.

7. The digital scale of claim 6, wherein the first mode of the touchscreen interface displays a total weight on the platform and the second mode of the touchscreen interface displays a total number of units placed on the platform.

8. The digital scale of claim 6, wherein the first mode of the touchscreen interface displays a total weight on the platform and the second mode of the touchscreen interface displays an average weight of each unit placed on the platform.

9. The digital scale of claim 1, further comprising a label printer, wherein the processor is configured to display at the touchscreen interface a third control button for causing the processor to print postage using the label printer, wherein the printed postage corresponds to a total weight on the platform when the postage is printed.

10. A digital scale comprising:
a platform;
an electrical sensor connected to the platform;
a processor connected to the electrical sensor;
a touchscreen interface connected to the processor;
wherein the processor is configured to implement a first mode of the touchscreen interface displaying at least a first value measured by the electrical sensor, and a first control button, and the processor is configured to implement a second mode of the touchscreen interface displaying at least a second control button that is different from the first control button.

11. The digital scale of claim 10, wherein the touchscreen is integrated into a housing that supports the platform and contains the electrical sensor.

12. The digital scale of claim 10, wherein the electrical sensor is a load cell.

13. The digital scale of claim 12, wherein the load cell incorporates a resistive strain gage.

14. The digital scale of claim 12, wherein the load cell incorporates a piezoelectric crystal.

15. The digital scale of claim 10, wherein each interface includes at least one control button to cause display of a different interface.

16. A control display comprising:
a processor;
a memory connected with the processor;
a load cell connected with the processor; and
a touchscreen connected with the processor;
wherein the processor is configured to retrieve from the memory and implement a first mode of the touchscreen displaying at least a first value and a first control button, and the processor is configured to retrieve from the memory and implement a second mode of the touchscreen displaying at least a second control button that is different from the first control button.

17. The control display of claim 16, wherein each mode includes at least one control button to cause display of a different interface.

18. The control display of claim 16, wherein the second control button is in a different part of the touchscreen from the first control button.

19. The control display of claim 16, wherein the second mode of the touchscreen displays a second value that is a different type of value than the first value.

20. The control display of claim 16, wherein the second mode of the touchscreen displays at least a portion that is a different color than the same portion in the first mode of the touchscreen.
